(19) United States
(12) Patent Application Publication
(10) Pub. No.: US 2026/0363436 A1
(43) Pub. Date: Nov. 19, 2026

(54) INTERLOCKING MECHANISM FOR CABINET WITH MULTIPLE DRAWERS

(71) Applicant: SJ GLOBAL MARKETING SDN. BHD., Muar (MY)

(72) Inventor: Meng Chong Tan, Bakri (MY)

(73) Assignee: SJ GLOBAL MARKETING SDN. BHD., Muar (MY)

(21) Appl. No.: 19/220,189

(22) Filed: May 28, 2025

(30) Foreign Application Priority Data
May 16, 2025 (MY) PI2025003019

(51) Int. Cl. A47B 88/443

(52) U.S. Cl. CPC A47B 88/443

(57) ABSTRACT

The present disclosure relates to an interlocking mechanism for cabinet with multiple vertically stacked drawers arranged in one or two different rows that the interlocking mechanism (100) only permits one of the drawers (210) to be drawn open to access a storage space defined thereto at one time. The interlocking mechanism (100) features a means to realize locking of the drawers located in the row adjacent to the open drawer.

### REFERENCE TO RELATED APPLICATIONS

This application claims the benefit of Malaysian Patent Application No. PI2025003019, titled “An Interlocking Mechanism For Cabinet With Multiple Drawers”, filed May 16, 2025, which is incorporated by reference herein in its entirety.

### TECHNICAL FIELD

The present disclosure relates to an interlocking mechanism for cabinet with multiple drawers, which are vertically stacked in one or two adjacently arranged rows. More specifically, the disclosed mechanism intrinsically prohibits opening or pulling out of the rest of the drawers when one of the drawers has been pull away from the cabinet.

### BACKGROUND

Cabinets typically have multiple drawers, often filled with various things. When all drawers are closed, the combined weight of the drawers is cantered thus keeping the cabinet stable. Opening a drawer shifts the weight away from the centre and create a force that pulls the cabinet off balance. Cabinets generally retain the stability as long as the remaining closed drawers provide enough weight to keep it upright. However, opening multiple drawers at the same time increases the risk of instability and tipping of the cabinet. Falling of a heavy can cause serious injury to anyone in front of it or damage both the cabinet and its contents. Therefore, different interlocking mechanism have been developed for cabinets to effectuate locking of other drawers passively when one of the drawers has been opened to improve usage safety. For example, United States patent no. 4,239,309 teaches about equipping a vertical bar with U-shaped hooks to latch onto the drawers thus preventing them from opening when the hooks are shifted vertically. When a drawer is pulled open, a ramp mechanism on its side moves the hook bar upward, locking the remaining drawers and preventing them from being opened simultaneously. Further, U.S. Patent No. 6,238,024, granted to Sawatzky, details an interlock system that incorporates rigid rods placed vertically between the cabinet drawers. These rods must be sized to match the vertical spacing of the drawers. If the cabinet configuration is altered, new rods corresponding to the updated drawer heights must be installed. Also, U.S. Patent No. 5,199,774, describes an interlock and lock system that operates using a cable. When a drawer is opened, the cable's slack is reduced. During installation, the cable's slack is precisely adjusted to ensure that only one drawer can be opened at a time. The interlock mechanism of the opened drawer absorbs the available slack, preventing other drawers from being opened simultaneously. Despite the above discussed invention indeed able to deliver the desired outcome, these mechanisms appeared to be complicated to install and prone to malfunction over a period of usage. Hence, a more robust and installation friendly interlocking mechanism would be greatly appreciated.

One object of the present disclosure is to provide an interlocking mechanism for cabinet or cabinet system. Specifically, the interlocking mechanism prohibits opening of more than one drawer of the cabinet thus reducing the likelihood of having the cabinet tipping due to imbalance.

Further object of the present disclosure aims to offer an interlocking mechanism equipped with a passive arrangement to interlock drawers installed at another row of the same cabinet.

More object of the present disclosure targets to offer an interlocking mechanism incorporated with enhanced features to ensure robustness of the disclosed mechanism to be used over a long period of time without any issues.

At least one of the preceding objects is met, in whole or in part, by the present disclosure, in which one of the embodiments of the present disclosure refers to an interlocking mechanism for a cabinet of a plurality of vertically stacked drawers arranged in two adjacent rows housed respectively in a first compartment and a second compartment separated by a divider wall of the cabinet, with each drawer being slidably mounting onto a neighbouring internal sidewall and the divider wall through a pair of guide rails. The interlocking mechanism preferably comprises a track having an elongate body with a top end and a bottom end, the track substantially running through a height of the divider wall defining a canal along the elongate body correspondingly facing the first compartment, the body of the track carrying a plurality of cut-out profile permitting accession of the second compartment from the first compartment thereto and vice versa; a top stoppage assembly and a bottom stoppage piece being secured to the top end and the bottom end of the track; a plurality of triggers each mounted to an external sidewall, which is adjacent to the divider wall upon installation of the drawer to the cabinet, of a corresponding drawer a plurality of locking assembly each comprising (i) a pivot base, (ii) a pair of a first and a second locking cams rotatably fixed to the pivot base being moveable in between an open position and a close position in connection to the opening and closing of a corresponding drawer respectively upon engaging the first or second locking cam to the corresponding drawer through the trigger, (iii) a spacer slidably displaceable away or towards the pivot base respectively corresponding to the open position and the close position of the right or left locking cam, and (iv) at least one connector, each locking assembly secured to the track in a sequential manner around the corresponding cut-out profile and downstream of the top stoppage assembly, the first and second locking cams being positioned in the first and second compartments respectively; at least one connection rod joining a preceding locking assembly to an immediate succeeding locking assembly using the connector of each locking assembly; a coil spring sandwiched between the top stoppage assembly and a topmost locking assembly being switchable between a first compressed level and an optimal second compressed level to constantly apply a tension force towards the plurality of locking assembly positioned downstream, the coil spring of the first compressed level being compressible further to the second compressed level providing a moveable space within the canal for one of the spacers to displace away from the pivot base upon the open position adapted by the corresponding locking assembly and vice versa. Preferably, the first and second locking cams of the plurality of locking assemblies engaging to the triggers of the corresponding drawers are in the close position when all the drawers are kept close in the cabinet with the coil spring adapting a first compressed level. More preferably, the first or second locking cam of one of the locking assemblies adapts the open position pushing the spacer away from the pivot base when the corresponding drawer is pulled away from the cabinet compressing the coil spring to the second compressed level, the spacers of other locking assemblies are prohibited to displace further preventing opening of the corresponding drawers engaged with other locking assemblies.

In some embodiments, the first or second locking cam adapted the open position displaces the spacer to engage with the hook of the neighbouring paired second or first locking cam in a fashion hindering rotation of the neighbouring paired second or first locking cam and prohibiting the adjacent drawer to be opened.

In some embodiments, the spacer comprises a first wedge paired with a second wedge shaped on planar surfaces of the spacer respectively protruding towards the first and second compartments that one of first and second wedges slides against the surface profile yanking the spacer progressively away from the pivot base upon turning the first or second locking cam to the open position from the close position following opening of the corresponding drawer and the paired second or first wedge is pushed to engage with the hook of the corresponding second or first locking cam.

In some embodiments, the surface profile comprises a convex ramp portion followed by a bevelled seat with a converging point formed in between the ramp and the seat at which the first or second wedge resting on the first or second locking cam upon the first or second locking cam adapts the open position.

For more embodiments, the first or second locking cam further comprises a first bump raised from the circumference adjacent to the seat to abut onto the first or second wedge and stop the first or second wedge from moving beyond upon the first or second locking cam adapts the open position.

For more embodiments, the trigger is free from being integrated into one of the paired guide rails.

For more embodiments, the canal is out of moveable space when the coil spring is at the second compressed level with one of the first or second locking cams of the locking assembly being switched to the open position thus prohibiting other locking assembly in the close position to adapt the open position.

For more embodiments, the top stoppage assembly comprises a housing in which a top block fixed to the housing, a bottom block, a spring member sandwiched in between the top and bottom blocks, and a top stoppage piece engaging to the housing located immediately downstream of the bottom block.

For more embodiments, the spring member adapts a compressed state associated to an upward displacement of the bottom block upon installation of the corresponding drawer into the cabinet for a first time and the spring member resumes a relaxed state associated to a downward displacement of the bottom block upon engagement of the locking cam with the trigger of the installed corresponding drawer.

In another aspect of the present disclosure, an interlocking mechanism for a cabinet of a plurality of vertically stacked drawers housed in the cabinet, with each drawer being slidably mounting onto internal sidewalls of the cabinet through a pair of guide rails. The interlocking mechanism comprises a track having an elongate body with a top end and a bottom end, the track substantially running through a height of the sidewall defining a canal along the elongate body; a top stoppage assembly and a bottom stoppage piece being secured to the top end and the bottom end of the track; a plurality of triggers each mounted to an external sidewall of a corresponding drawer; a plurality of locking assembly each comprising (i) a pivot base, (ii) a locking cams rotatably fixed to the pivot base being moveable in between an open position and a close position in connection to the opening and closing of a corresponding drawer upon engaging the locking cam to the corresponding drawer through the trigger, (iii) a spacer slidably displaceable away or towards the pivot base corresponding to the open position and the close position of the locking cam, and (iv) at least one connector, each locking assembly secured to the track in a sequential manner downstream of the top stoppage assembly; at least one connection rod joining a preceding locking assembly to an immediate succeeding locking assembly using the connector of each locking assembly; a coil spring sandwiched between the top stoppage assembly and a topmost locking assembly, the coil spring being switchable between a first compressed level and an optimal second compressed level to constantly apply a tension force towards the plurality of locking assembly positioned downstream, the coil spring of the first compressed level being compressible further to the second compressed level providing a moveable space within the canal for one of the spacers to displace away from the pivot base upon the open position adapted by the corresponding locking assembly and vice versa. Preferably, the locking cams of the plurality of locking assemblies engaging to the triggers of the corresponding drawers are in the close position when all the drawers are kept in the cabinet with the coil spring adapting a first compressed level. More preferably, the locking cam of one of the locking assemblies adapts the open position pushing the spacer away from the pivot base when the corresponding drawer is pulled away from the cabinet compressing the coil spring to the second compressed level, the spacers of other locking assemblies are prohibited to displace further on the track preventing opening of the corresponding drawers engaged with other locking assemblies.

### BRIEF DESCRIPTION OF THE DRAWINGS

FIG. 1 shows perspective explosive view of one embodiment of the interlocking mechanism without the trigger;

FIG. 2 shows position of the trigger, compatible with the embodiment shown in FIG. 1, in relation to the guide rails;

FIG. 3 shows the embodiment of FIG. 1 and 2 being assembled;

FIG. 4 shows one embodiment of (a) the track, (b) the coil spring, (c) the connection rod and (d) the trigger;

FIG. 5 shows one embodiment of the spacer used in (a) the topmost locking assembly and (b) the rest of the locking assembly;

FIG. 6 shows an embodiment of the (a) first locking cam and (b) second locking cam;

FIG. 7 shows one embodiment of the pivot base carrying a connector;

FIG. 8 shows one embodiment of (a) the top stoppage piece of the top stoppage assembly and (b) the bottom stoppage piece;

FIG. 9 illustrates explosive view of one embodiments of the top stoppage assembly including the top stoppage piece;

FIG. 10 shows one embodiment of (a) the trigger being mounted on one of the side of the drawer together with the rail guide and (b) the locking mechanism without the trigger being installed on the divider wall of the cabinet;

FIG. 11 illustrates another embodiment of the disclosed interlocking mechanism applicable to cabinet with single row of stacked drawers; and

FIG. 12 illustrates one embodiment of the locking cam used in the embodiment shown in FIG. 11.

### DETAILED DESCRIPTION

The present disclosure may be embodied in other specific forms without departing from its structures, methods, or other essential characteristics as broadly described herein and claimed hereinafter. The described embodiments are to be considered in all respects only as illustrative, and not restrictive. The scope of the disclosure is, therefore, indicated by the appended claims, rather than by the foregoing description. All changes that come within the meaning and range of equivalency of the claims are to be embraced within their scope.

As used herein, the terms “approximately” or "about", in the context of concentrations of components, conditions, other measurement values, etc., means +/- 5 % of the stated value, or +/- 4 % of the stated value, or +/- 3 % of the stated value, or +/- 2 % of the stated value, or +/- 1 % of the stated value, or +/- 0.5 % of the stated value, or +/- 0 % of the stated value.

The directional term such as “top”, “bottom”, “parallel”, “side”, “perpendicular”, “external”, “internal”, “vertical” and “horizontal” used herein throughout the specification generally refers to the relative direction of the various components of the disclosed mechanism or system with regard to the condition of the cabinet installed with the disclosed mechanism.

The term “neighboring” used herein throughout the specification shall refer to an arrangement of two or more components substantially in tandem with one and other or juxtaposing manner around a horizontal axis or plane. For example, the neighboring drawer of the topmost drawer in the first compartment of the cabinet described in the following description refers to the topmost drawer in the second compartment unless mentioned otherwise.

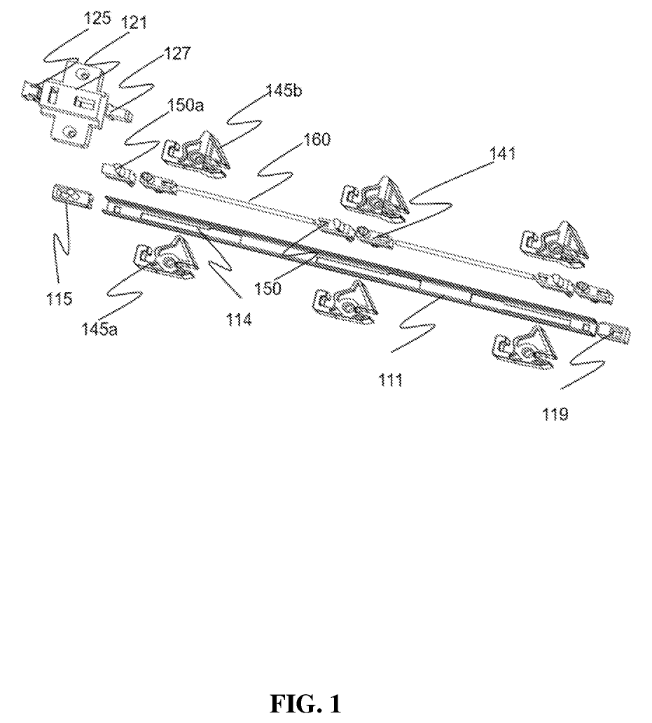

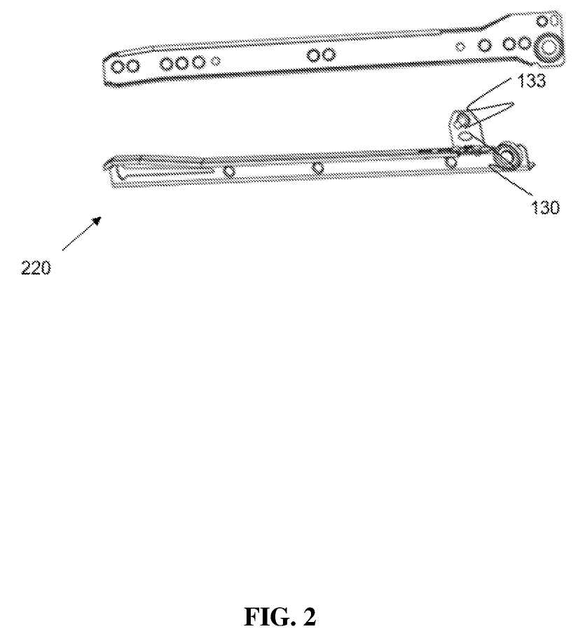

Referring to FIG. 1-3, one embodiment of the disclosed interlocking mechanism (100) is illustrated. Particularly, the disclosed interlocking mechanism (100) is applicable for a cabinet (200) of a plurality of vertically stacked drawers (210) arranged in two adjacent rows housed respectively in a first compartment (201) and a second compartment (202) separated by a divider wall (250) of the cabinet (200). Preferably, each drawer (210) is slidably mounted onto a neighbouring internal sidewall (230) and the divider wall (250) of the cabinet (200) through a pair of guide rails (220). The disclosed interlocking mechanism (100) or system generally comprises a track (110) having an elongate body with a top end and a bottom end, the track (110) substantially running through a height of the divider wall (250) defining a canal (111) along the elongate body correspondingly facing the first compartment (201), the body of the track (110) carrying a plurality of cut-out profile (114) permitting accession of the second compartment (202) from the first compartment (201) thereto and vice versa; a top stoppage assembly (120) and a bottom stoppage piece (119) being secured to the top end and the bottom end of the track (110); a plurality of triggers (130) each mounted to an external sidewall, which is adjacent to the divider wall (250) upon installation of the drawer (210) to the cabinet (200), of a corresponding drawer (210); a plurality of locking assembly (140) each comprising (i) a pivot base (141), (ii) a pair of a first (145a) and a second locking cams (145b) rotatably fixed to the pivot base (141) being moveable in between an open position and a close position in connection to the opening and closing of a corresponding drawer (210) respectively upon engaging the first (145a) or second locking cam (145b) to the corresponding drawer (210) through the trigger (130), (iii) a spacer (150) slidably displaceable away or towards the pivot base (141) respectively corresponding to the open position and the close position of the first (145a) or second locking cam (145b), and (iv) at least one connector (168), each locking assembly (140) secured to the track (110) in a sequential manner around the corresponding cut-out profile (114) and downstream of the top stoppage assembly (120), the first (145a) and second locking cams (145b) being positioned in the first (201) and second compartments (202) respectively; at least one connection rod (160) joining a preceding locking assembly (140) to an immediate succeeding locking assembly (140) using the connector (168) of each locking assembly (140); a coil spring (170) sandwiched between the top stoppage assembly (120) and a topmost locking assembly (140a), the coil spring (170) being switchable between a first compressed level and an optimal second compressed level to constantly apply a tension force towards the plurality of locking assembly (140) positioned downstream, the coil spring (170) of the first compressed level being compressible further to the second compressed level providing a moveable space within the canal (111) for one of the spacers (150) to displace away from the pivot base (141) upon the open position adapted by the corresponding locking assembly (140) and vice versa. Preferably, the first (145a) and second locking cams (145b) of the plurality of locking assemblies (140) engaging to the triggers (130) of the corresponding drawers (210) are in the close position when all the drawers (210) are kept in the cabinet (200) with the coil spring (170) adapting a first compressed level. On the other hand, the first (145a) or second locking cam (145b) of one of the locking assemblies (140) adapts the open position pushing the spacer (150) away from the pivot base (141) when the corresponding drawer (210) is pulled away from the cabinet (200) compressing the coil spring (170) to the second compressed level, the spacers (150) of other locking assemblies (140) are prohibited to displace further preventing opening of the corresponding drawers (210) engaged with other locking assemblies (140).

It is crucial to note that the divider wall (250) runs from a top to a bottom of the cabinet (200) such that a space defined within the cabinet (200) is symmetrically or equally divided into the first compartment (201) and the second compartment (202). The divider wall (250) shall possess sufficient thickness for substantial embedment of the track (110) and attachment of other components of the disclosed interlocking mechanism (100) to the embedded track (110). The first compartment (201) can be any one of the right-sided or left-sided compartment while the second compartment (202) is the space or compartment neighbouring to the first compartment (201) and separated from the first compartment (201) by the divider wall (250). The first row of the drawers (210) is kept in the first compartment (201) and the second row of the drawers (210) are installed at the second compartment (202).

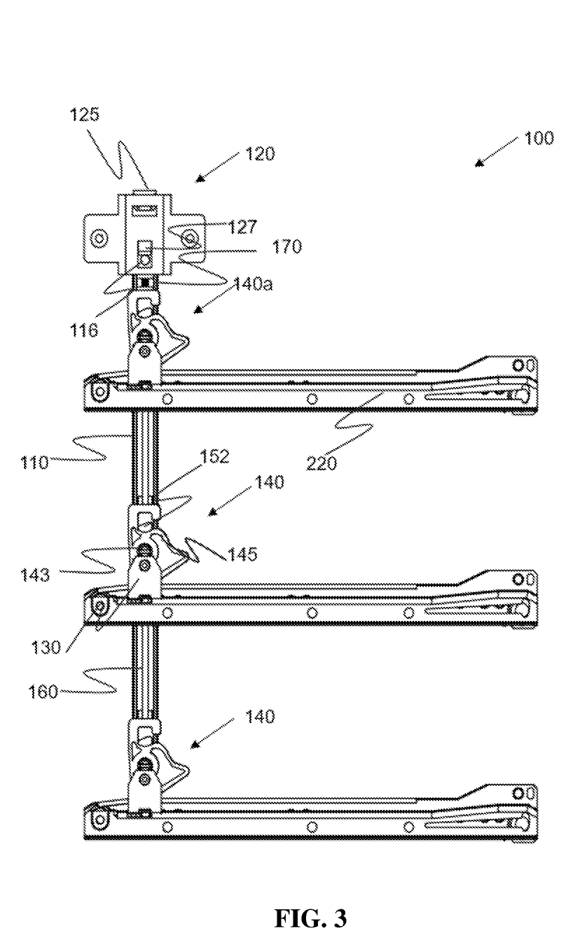

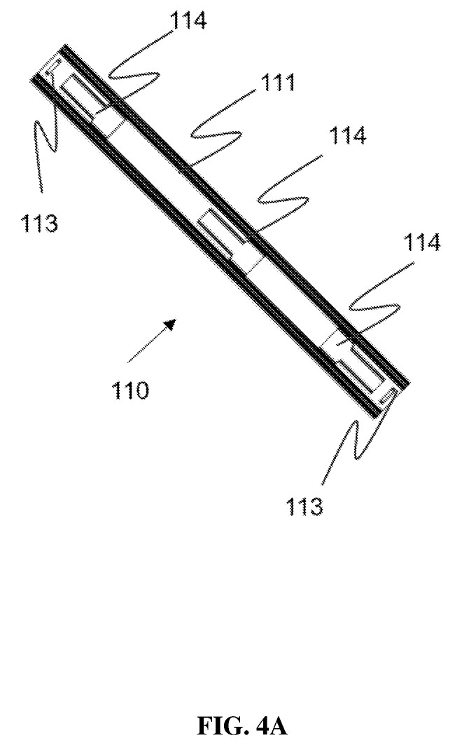

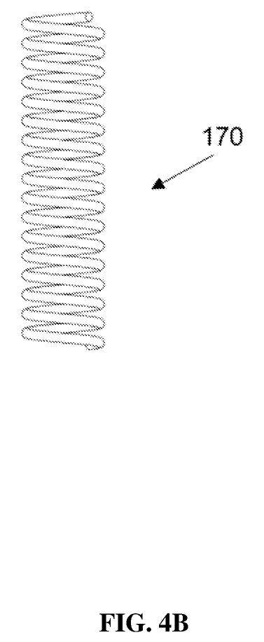

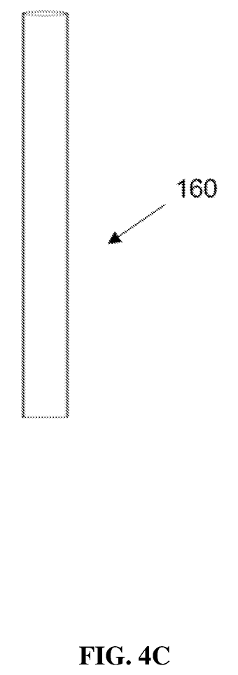

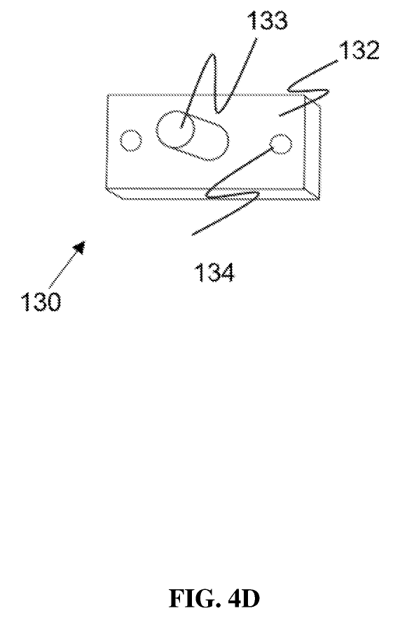

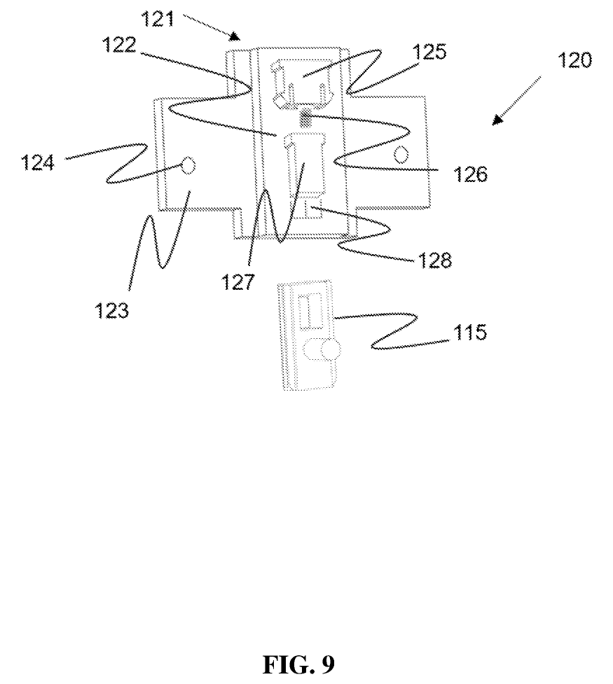

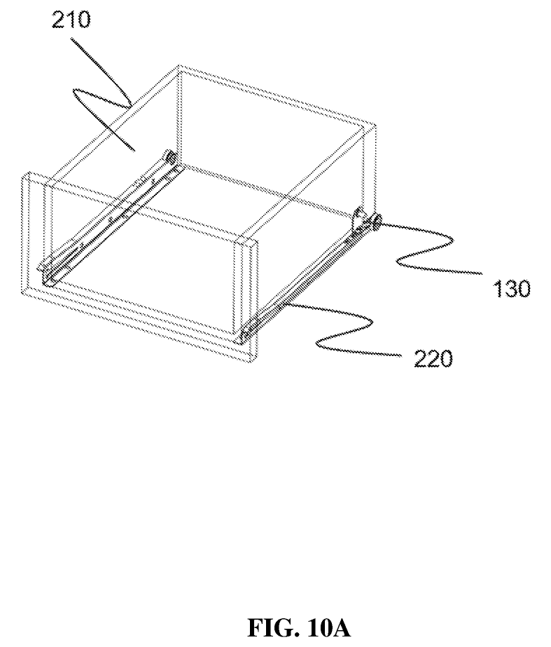

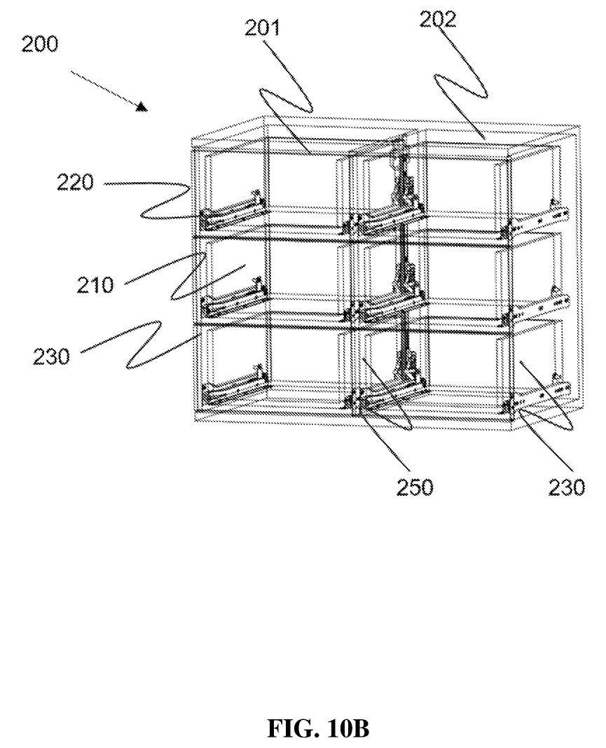

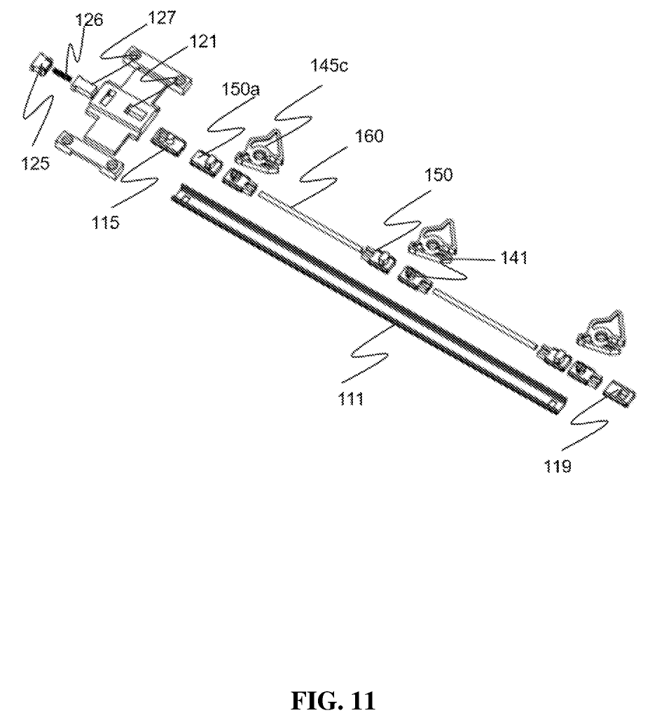

From FIG. 3, one embodiment of the assembled interlocking mechanism (100) can be seen from a side view. The disclosed interlocking mechanism (100) has the top stoppage assembly (120) positioned around the top end of the track (110) followed by the topmost locking assembly (140a) and subsequent locking assemblies (140) arranged in a sequential manner downstream of the top stoppage assembly (120) as shown in FIG. 3. A locking assembly (140) connects to another locking assembly (140), either located upstream or downstream, via coupling between a connector (168) and a connection rod (160) as illustrated in FIG. 4c. Through such arrangement, the tension force produced from the coil spring (170) at the first compressed level or state can be applied towards all the locking assemblies (140) for better engagement with the installed drawers (210) through the trigger (130). Referring further to FIG. 9 together with FIG. 3, the top stoppage assembly (120) possesses a cross-shaped planar body or housing (121) with a vertical part (122) defining a groove therein to be aligned towards the downstream track (110) and a pair of flanges (123) expanding out from the side of the vertical part (122). Each of the flanges (123) carries at least one bore to receive a screw (124) thereto for attaching the top stoppage assembly (120) onto the divider wall (250). A pair of C-shaped straps (not shown) may be used together with the screws (124) to assist attachment of the top stoppage assembly (120) that each of the strap bears the hole of similar size to the bore on the flange (123) for insertion of the screw (124) upon aligning the bore of the flange (123) with the hole of the strap. Within the groove, a top block (125) fixed to the vertical part (122), a spring member (126), a bottom block (127) and the top stoppage piece (115) are placed in tandem from top to down towards the track (110). Particularly, the top stoppage assembly (120) essentially comprises the housing (121) in which the top block (125) fixed to the housing (121), the bottom block (127), the spring member (126) sandwiched in between the top (125) and bottom blocks (127), and the top stoppage piece (115) engaging to the housing (121) located immediately downstream of the bottom block (127). The coil spring (170) is further sandwiched in between the top stoppage piece (115) and the spacer (150) of the topmost locking assembly (140a). The façade of the vertical part (122) bears a cutout (128) to accept a dowel (116) of the top stoppage piece (115) therein to abut onto the bottom block (127) that the dowel (116) ascends upward in the cutout (128) to thrust the bottom block (127) upward compressing the spring member (126) upon installation of a drawer (210) for the first time into the cabinet (200). On the other hand, the dowel (116) stayed caught within the cutout (128) without compressing the spring member (126) when the coil spring (170) becomes compressed in association to opening of one of the drawers (210) installed to the cabinet (200).

It is important to note that both spring member (126) and coil spring (170) are compressible to provide a temporary displaceable gap or space along the canal (111) pursuant to different actions being applied towards the drawers (210). For instance, when the topmost drawer (210) of the first compartment (201) is installed into the cabinet (200) for the first time, pushing in the topmost drawer (210) through the paired guide rails (220) brings the trigger (130) to contact with the first locking cams (145a) of topmost locking assembly (140a) that the pushing force progressively edges the topmost first locking cam (145a) upward along with the whole topmost locking assembly (140a) pressing the spring member (126) into a compressed state. Compression of the spring member (126) creates a space or gap downstream permitting the guide rail (220) of the topmost drawer (210) to slide in across the track (110) until a pole (133) of the pole (133) of the trigger (130) intrinsically slides into a slot (208) of the topmost first locking cam (145a) thus resuming the relax state of the spring member (126) while having the topmost locking assembly (140a) engaged with the trigger (130). Similar course or manoeuvre mentioned above shall happen to other drawers (210) being installed to the cabinet (200) for the first time as well capitalizing on the compression movement of the spring member (126) and arrangement of the locking assemblies (140) to realize intrinsic engagement of the installed drawer (210) to the interlocking mechanism (100) without much effort needed from the user. In more particular, the spring member (126) adapts a compressed state associated to an upward displacement of the bottom block (127) upon installation of the corresponding drawer (210) into the cabinet (200) for a first time and the spring member (126) resumes a relaxed state associated to a downward displacement of the bottom block (127) upon engagement of the locking cams (145) with the trigger (130) of the installed corresponding drawer (210).

As to the coil spring (170), it serves to interlock the drawers (210) located downstream and/or upstream of the opening drawers (210) on both first (201) and second compartments (202). Particularly, all the components resided in the canal (111) are subjected to the tension force applied downward from the coil spring (170) of the first compressed level once all the drawers (210) are installed and adapts the close position. Yet the moveable or displaceable space exits under the condition where the coil spring (170) is depressed further to reach the second compressed level. When one of the drawers (210) takes the open position, the locking cam (145) of the given locking assembly (140) yanks the spacer (150) away pressing the coil spring (170) to adapt the second compressed level while the wedge (152) traverse across the surface profile (144) to arrive at and rest on the seat (148) of the surface profile (144) rendering the canal (111) out of moveable space thus prohibiting other locking assemblies (140) in the close position to adapt the open position.

For a number of the disclosed embodiments, the trigger (130), as present in FIG. 4b, comprises a base (132) and a pole (133) projecting away from the planar surface of the base (132). The base (132) may bear one or more screw holes (134) for fixing the base (132) onto the external surface of the sidewall of the drawer (210). The disclosed mechanism (100) uses the pole (133) of the trigger (130) to couple with the first (145a) or second locking cam (145b) of the corresponding locking assembly (140) to mechanically link the drawer (210) to attain the desired interlocking outcome. Also, the trigger (130), in these embodiments, is free from being integrated into one of the paired guide rails (220). Such design of the trigger (130) facilitates application of the disclosed mechanism (100) to any other existing cabinet or cabinet system to obtain the interlocking outcome without much hassle, as long as the trigger (130) is fixed to the external surface of the sidewall of the drawer (210) corresponding to the position of the locking assembly (140) which the trigger (130) to be engaged with.

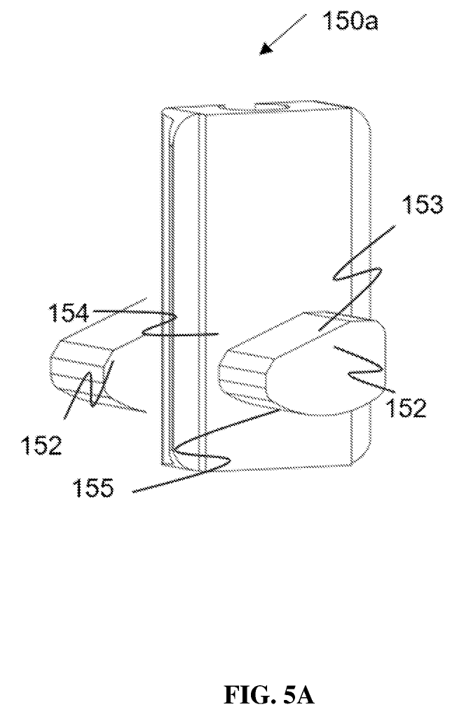

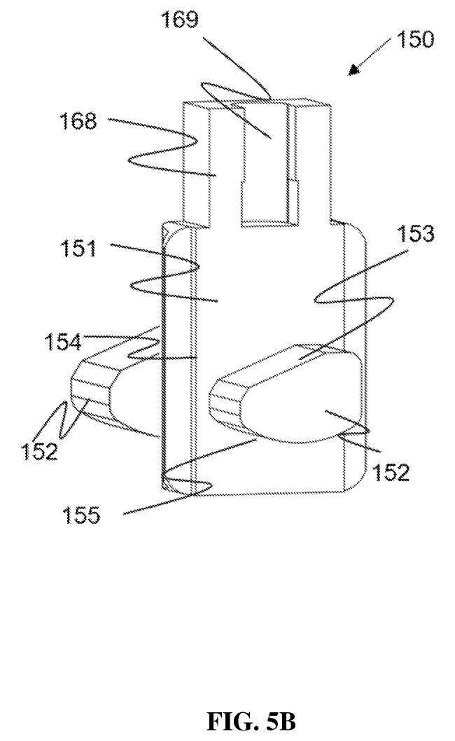

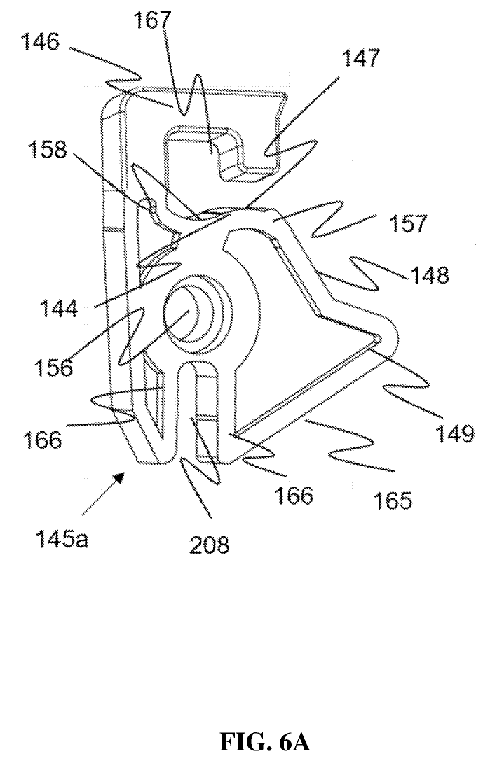

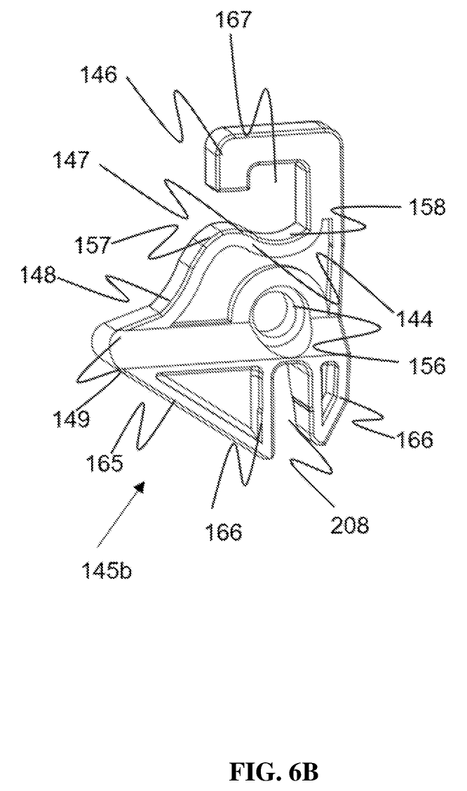

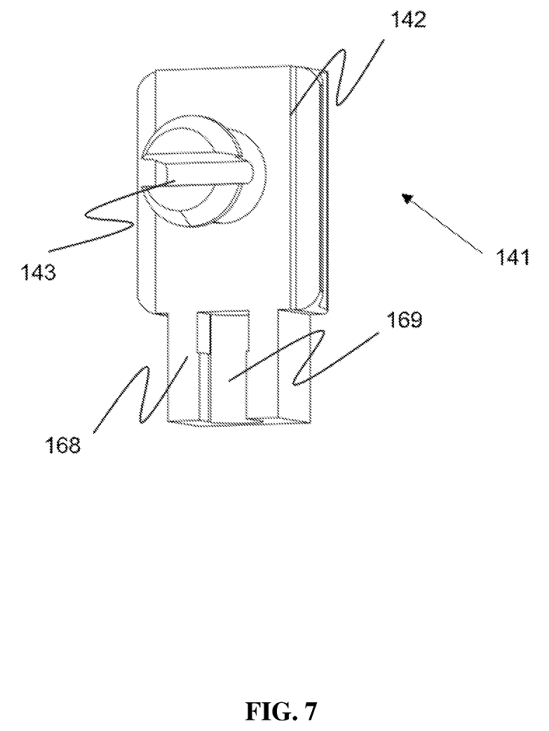

As mentioned in the foregoing description, the locking assembly (140) comprises at least three different parts comprises the spacer (150) as illustrated in FIG. 5a and 5b, the first locking cam (145a) and the second locking cam (145b) shown in FIG. 6a and 6b, and the pivot base (141) present in FIG. 7. Preferably, all these parts are shaped and sized to have identical or almost identical width and thickness such that these parts can be naturally fitted into the canal (111) and capable of sliding within the canal (111) in connection to the switching of the open and close position of the locking cam (145) of one of the locking assemblies (140). The FIGS. 5a and 5b respectively show one embodiment of the topmost spacer (150a) used for the locking assembly (140) and the spacer (150) constructing the locking assembly (140) other than the topmost variant. In general, the spacer (150 or 150a) is an elongate block (151) carrying a wedge (152), namely a first wedge or a second wedge, on each of its planar elongate surfaces facing towards the first (201) or second compartment (202). More specifically, the spacer (150) comprises the first wedge (152) paired with the second wedge (152) shaped on planar surfaces of the spacer (150) respectively protruding towards the first (201) and second compartments (202) that one of first and second wedges (152) slides against the surface profile (144) yanking the spacer (150) progressively away from the pivot base (141) upon turning of the corresponding locking cam (145) to the open position from the close position following opening of the corresponding drawer (210) and the paired second or first wedge (152) is pushed to engage or fasten with the hook (146) of the corresponding second (145b) or first locking cam (145a) blocking the opening of the drawer (210) neighbouring to the opening drawer (210). Preferably, the bottom circumference of the wedge (152) is designated to contact with a surface profile (144) carved around at least a portion of a circumference of the corresponding locking cam (145) that sliding the wedge (152) against the surface profile (144) yanks the spacer (150) progressively away from the pivot base (141) upon turning the locking cam (145) to the open position from the close position. Owing to the convex or raising ramp (147) on the surface profile (144) of the locking cam (145), rotational movement of the locking cam (145) is translated into a linear motion of the corresponding spacer (150) upward further compressing the coil spring (170) towards the second compressed level. At the second compressed level, the coil spring (170) is fully or almost fully compressed. The maximum distance of the spacer (150) being displaceable away from the pivot base (141), in connection to the switching of the close position to the open position by the locking assembly (140), shall equal or correspond to the linear compression or linear changes in length of the coil spring (170) adapting the second compressed level from the first compressed level. The top circumference of the wedge (152) may be shaped to have a top bevel (153) with a land (154) forming one of the side circumferences then progressively curves into the bottom convex or arc circumference (155). Another side circumference of the wedge (152) is flattened as shown in FIG. 5a and 5b. The arc bottom circumference (155) facilitates sliding of the wedge (152) about the surface profile (144) of the locking cam (145) free from any significant friction that may cause wearing of the surface profile (144) after long period of use of the cabinet (200). For the variant in FIG. 5b, a connector (168) or an upward connector becomes an upward extension from the elongate block (151) defining a channel (169) for snug fitting or reception of the connection rod (160) thereto. Since the topmost variant of the spacer (150a) has no need to fasten onto the connection rod (160), the topmost variant of the spacer (150a) is free from having the connector (168) as illustrated in FIG. 5a. The disclosed mechanism (100) ensures the spacer (150) is lifted by the corresponding drawer (210) in the first compartment (201) or second compartment (202) adapted the open position through the rotating locking cam (145) abutting and yanking the wedge (152) of the corresponding spacer (150). Meanwhile, the wedge (152) on another planar side of the lifted spacer (150) shall be brought upwards as well to engage with a hook (146) of the corresponding first (145a) or second locking cam (145b) despite it is free from being abutted by the surface profile (144) of the corresponding first (145a) or second locking cam (145b) located in the compartment neighbouring to the open drawer (210). Engagement of the wedge (152) with the hook (146) impedes opening of the drawer (210) adjacent or neighbouring to the open drawer (210).

Correspondingly, FIG. 6a and 6b respectively illustrates one embodiment of the first (145a) and second locking cam (145b). Both first (145a) and second locking cam (145b) (or both generally referred as locking cam (145)) share most of the common features. The locking cam (145a or 145b) appears as a planar piece with a through aperture (156) fabricated around the centre for coupling with the pivot base (141) to realize the rotational movement for switching between the open position and the close position. In some embodiments, the first (145a) and/or second locking cam (145b) comprises a hook (146) raised from a circumference of the locking cam (145a or 145b) adjacent to a surface profile (144) which is designated to abut and slidably displace the spacer (150 or 150a) away or towards the pivot base (141) corresponding to opening or closing of the corresponding drawer (210). Preferably, the locking cam (145) retains a predetermined thickness to have sufficient surface area directed to physical engagement with the wedge (152) of the spacer (150) and the pole (133) of the trigger (130). The disclosed mechanism (100) preferably disposes the surface profile (144) around the top circumference of the locking cam (145). The surface profile (144) comprises a convex ramp (147) portion followed by a bevelled seat (148) extending sideway with a converging point (157) formed in between the ramp (147) and the seat (148) at which the wedge (152) resting on the locking cam (145) upon the locking cam (145) adapts the open position. Particularly, the wedge (152) rests on the trough (158) of the ramp (147) when the given locking assembly (140) is in the close position. The wedge (152) advances across the ramp (147) from the trough (158) to reach the seat (148) for the corresponding locking cam to adapt the open position from the close position. The wedge (152) engages onto the seat (148) when the given locking assembly (140) and the corresponding drawer (210) are in the open position. The locking cam (145) further comprises a hook (146) raised from the circumference of the locking cam (145) adjacent to the surface profile (144), more preferably adjacent to the trough (158), to abut onto the wedge (152) and stop the wedge (152) from moving beyond upon resuming the close position by the locking cam (145). Similarly, the locking cam (145) further comprises a first bump (149) raised from the circumference of the locking cam (145) adjacent to the seat (148) to abut onto the wedge (152) and stop the wedge (152) from moving beyond upon adapting the open position by the locking cam (145). Also, a room (167) defined within the hook (146) is designated to physically engage or fasten with the lifted wedge (152) of a close drawer (210) neighbouring to an open drawer (210) thus impeding opening of the close drawer (210) thereof. Particularly, the first (145a) or second locking cam (145b) adapted the open position displaces the spacer (150) to engage with the hook (146) of the neighbouring paired second (145b) or first locking cam (145a) in a fashion hindering rotation of the neighbouring paired second (145b) or first locking cam (145a) and prohibiting opening of the adjacent drawer (210). The corresponding locking cam (145) of the open drawer (210) is turned to the open position free from fastening the hook (146) to lifted wedge (152). Furthermore, the locking cam (145) further comprises a pair of bifurcated prongs (166), namely a first prong and a second prong, projecting downward and away around the bottom circumference with a slot (208) defined in between the prongs (166). Particularly, the pole (133) of the trigger (130) glides into the slot (208) of the corresponding locking cam (145) upon insertion of the corresponding drawer (210) into the cabinet (200). Preferably, a slope (165) slants towards the second prong from the first bump (149) to facilitate upward edging of the corresponding locking assembly (140) (and others connecting locking assemblies (140) located upstream along the track) and compression of the spring member (126) by the pole (133) of the trigger (130) of the inserting corresponding drawer (210), as described in the foregoing, until the pole (133) finally glides into the slot (208). Accordingly, the room (167), the aperture (156) and the slot (208) of the locking cam (145) are substantially aligned along a vertical axis. FIG. 6b illustrates an embodiment locking cam (145), which may preferably used as the second locking cam (145b) in some embodiments of the disclosed mechanism (100), having a section with increased thickness to space the hook (146) further away from the track (110) to result better engagement of the lifted wedge (152) and the hook (146). These locking cams (145b) of increased thickness are preferably applied to the compartment in which the canal (111) of the track (110) is absence.

To realize rotational movement of the locking cam (145), one embodiment of the pivot base (141) is illustrated in FIG. 7. The pivot base (141) preferably comprises an elongate body (142) on each planar surface of which a pivot hinge (143) is fabricated to be inserted and coupled to the through aperture (156) of the locking cam (145) for enabling the rotational movement thereby. Similarly, the body (142) of the pivot base (141) further comprises a connector (168) or a downward connector, which is a downward extension from the elongate body (142) defining a channel (169) for snug fitting or reception of the connection rod (160). Two successive locking assemblies (140) of the disclosed mechanism (100) can be connected by having the downward connector (168) from the pivot base (141) of a preceding locking assembly (140) and the upward connector from the spacer (150) of a succeeding locking assembly (140) fastening onto a top tip and bottom tip of a connection rod (160) respectively.

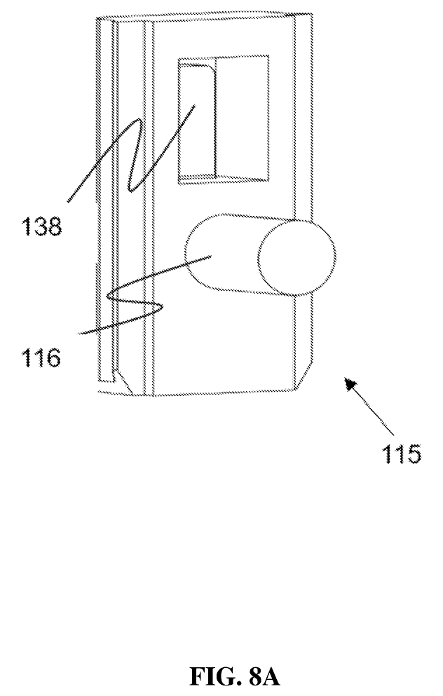

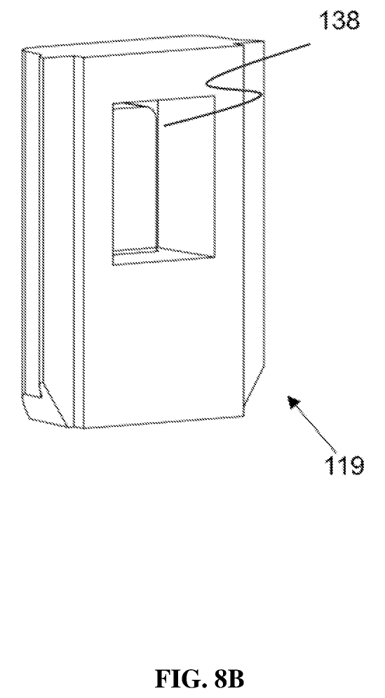

Attention shall now be given to FIG. 8a and 8b showing one embodiment of the top and bottom stoppage piece (119) respectively. The top stoppage piece (115), partly accommodated in the top stoppage assembly (120), comprises a planar block partly residing within the top stoppage assembly (120) and the dowel (116) perpendicularly protruding away from the block outreaching into the cutout (128) of top stoppage assembly (120). Segment of the block projecting out from the bottom of the housing (121) of the top stoppage assembly (120) may be residing inside the canal (111) of the track (110). On the top stoppage piece (115), a protuberance (not shown) is made on the back of the block with a corresponding depression (138) fabricated at the section of the block slightly above of the dowel (116) for securing the top stoppage piece (115) onto a bore (113) located around top end of the track (110) in some of the embodiments. The top stoppage piece (115) further couples with the bottom block (127) in a manner facilitating the lifting of the bottom block (127). The back of the block around the portion protruding out of the housing (121) towards the canal (111) may be carved with a gutter to keep part of the coil spring (170). Similarly, the bottom stoppage piece (119), as shown in FIG. 8b, comprises the planar block without the dowel but carrying the like protuberance (not shown) to mount on the corresponding bore (113) at the bottom end of the track (110). A depression (134) can be seen on the front of the block to denote the location of the fitting at the back.

Pursuant to the preferred embodiments, most of the components except the trigger (130) are mounted or resided in the track (110) directly or indirectly. The track (110) is preferably snugly resided in a longitudinal recess fabricated on the divider wall (250) of the cabinet (200) for the disclosed mechanism (100) or system working on two rows of stacked drawers (210). As to cabinet (200) with only single row of drawers (210), the track (110) is held along the recess carved on one of the internal sidewalls (230) in a fashion similar or almost similar to its counterpart kept along the divider wall (250). The recess may have a length greater than the length of the track (110) in some of the embodiments. The track (110), as shown in 4a, may possess a pair of bores (113) each respectively positioned around the top and bottom end for respective securement of the top (115) and bottom stoppage piece (119). For the interlocking mechanism (100) operable on at least two rows of drawers (210), a number of cut-out profiles (114) can be found equidistantly spaced apart along the track (110) for attachment of the corresponding the locking assemblies (140). Part of the locking assemblies (140) such as a neighbouring locking cam (145) and/or wedge (152) can be traversed into the second compartment (202) from the first compartment (201) through the cut-out profile (114). The number of cut-out profiles (114) available on the track (110) shall match the number of drawer or the locking assemblies (140) deployed to the cabinet (200).

Once all the drawers (210) are installed and adapts the close position, all the components resided in the canal (111) are subjected to the tension force applied downward from the coil spring (170) of the first compressed level holding the components in place. Yet the moveable or displaceable space exits under the condition where the coil spring (170) is depressed further to reach the second compressed level. The displaceable or moveable space corresponds to the linear changes of the length of the coil spring (170) upon further compression. The optimal moveable or displaceable space shall be in line with optimal linear changes of the length of the coil spring (170) until it reaches the second compressed level and the distance the spacer (150) being displaced away from the pivot base (141) when the given locking assembly (140) takes the open position. When one of the locking assemblies (140) takes the open position, the locking cam (145) of the given locking assembly (140) yanks the spacer (150) away pressing the coil spring (170) to adapt the second compressed level while the wedge (152) traverse across the surface profile (144) to arrive at and rest on the seat (148) of the surface profile (144). Meanwhile, the slot (208) of the locking cam (145) of the given assembly (140) is turned forward for the trigger (130) to slidable disengages from the given locking assembly (140) to realize opening of the drawer (210). The distance separating the spacer (150) and the pivot base (141) occupies or uses up the moveable space rendering insufficient space within the canal (111) for the rest of the locking assemblies (140) to rotate and release the disengage the trigger (130). In more specific, the canal (111) is out of moveable space when the coil spring (170) is at the second compressed level with one of the locking assemblies (140) being switched to the open position thus prohibiting other locking assembly (140) in the close position to adapt the open position. Other drawers (210) except the drawer (210) neighbouring to the opening drawer (210) are prohibited from being pulled open under the same process or operation.

According to another aspect of the present disclosure, an interlocking mechanism (100) for a cabinet (200) of a plurality of vertically stacked drawers (210) arranged in a single row and housed in the cabinet (200) is disclosed. Each drawer (210) isa slidably mounted onto internal sidewalls (230) of the cabinet (200) through a pair of guide rails (220). In some embodiments, the disclosed interlocking mechanism (100) comprises a track (110) having an elongate body with a top end and a bottom end, the track (110) substantially running through a height of the sidewall (230) defining a canal (111) along the elongate body; a top stoppage assembly (120) and a bottom stoppage piece (119) being secured to the top end and the bottom end of the track (110); a plurality of triggers (130) each mounted to an external sidewall of a corresponding drawer (210); a plurality of locking assembly (140) each comprising (i) a pivot base (141), (ii) a locking cams (145c) rotatably fixed to the pivot base (141) being moveable in between an open position and a close position in connection to the opening and closing of a corresponding drawer (210) upon engaging the locking cam (145c) to the corresponding drawer (210) through the trigger (130), (iii) a spacer (150) slidably displaceable away or towards the pivot base (141) corresponding to the open position and the close position of the locking cam (145c), and (iv) at least one connector (168), each locking assembly (140) secured to the track (110) in a sequential manner downstream of the top stoppage assembly (120); at least one connection rod (160) joining a preceding locking assembly (140) to an immediate succeeding locking assembly (140) using the connector (168) of each locking assembly (140); a coil spring (170) sandwiched between the top stoppage assembly (120) and a topmost locking assembly (140a) being switchable between a first compressed level and an optimal second compressed level to constantly apply a tension force towards the plurality of locking assembly (140) positioned downstream, the coil spring (170) of the first compressed level being compressible further to the second compressed level providing a moveable space within the canal (111) for one of the spacers (150) to displace away from the pivot base (141) upon the open position adapted by the corresponding locking assembly (140) and vice versa. Preferably, the locking cams (145c) of the plurality of locking assemblies (140) engaging to the triggers (130) of the corresponding drawers (210) are in the close position when all the drawers (210) are kept in the cabinet (200) with the coil spring (170) adapting a first compressed level. Moreover, the locking cam (145c) of one of the locking assemblies (140) adapts the open position pushing the spacer (150) away from the pivot base (141) when the corresponding drawer is pulled away from the cabinet (200) compressing the coil spring (170) to the second compressed level, the spacers (150) of other locking assemblies (140) are prohibited to displace further on the track (110) preventing opening of the corresponding drawers (210) engaged with other locking assemblies (140).

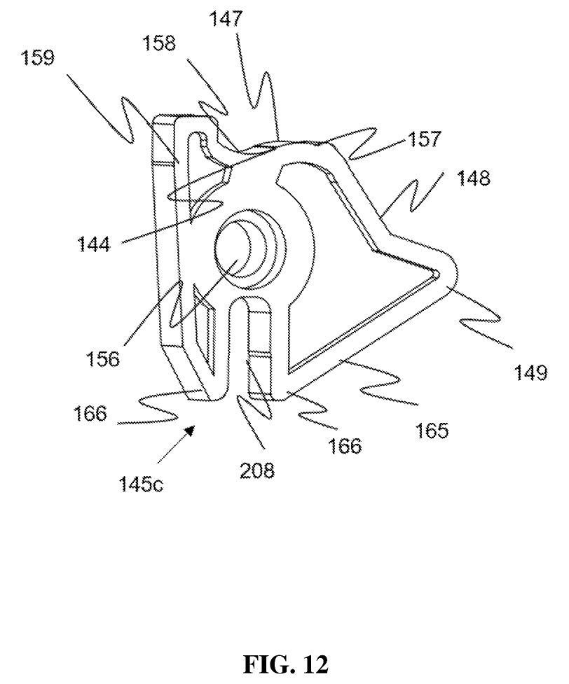

It is worthy to note that the disclosed interlocking mechanism (100) for single row of drawers (210) employs most of the components and arrangements identical or almost identical to the embodiments used for double-row of drawers (210) described above except the locking assemblies (140), the track (110), etc. For instance, the locking cam (145c) employed for single row drawer (210) shall free from any hook (146), which is used to fasten on the corresponding wedge (152) to lock the drawer (210) upon opening of the neighbouring drawer (210), as shown in FIG. 12. Rather, the hook (146) is replaced by a raised second bump (159) next to the trough to impede movement of the corresponding wedge (152) beyond the trough.

Like the counterpart mechanism (100) used for double row of drawers (210), the top stoppage assembly (120) for single row of drawers (210) comprises a housing (121) in which a top block (125) fixed to the housing (121) , a bottom block (127), a spring member (126) sandwiched in between the top (125) and bottom blocks (127), and a top stoppage piece (115) engaging to the housing (121) located immediately downstream of the bottom block (127) in some embodiments. Also, the spring member (126) adapts a compressed state associated to an upward displacement of the bottom block (127) upon installation of the corresponding drawer (210) into the cabinet (200) for a first time and the spring member (126) resumes a relaxed state associated to a downward displacement of the bottom block (127) upon engagement of the locking cam (145c) with the trigger (130) of the installed corresponding drawer (210). It is to be understood that the present disclosure may be embodied in other specific forms and is not limited to the sole embodiment described above. However, modification and equivalents of the disclosed concepts such as those which readily occur to one skilled in the art are intended to be included within the scope of the claims which are appended thereto.

1. An interlocking mechanism for a cabinet of a plurality of vertically stacked drawers arranged in two adjacent rows housed respectively in a first compartment and a second compartment separated by a divider wall of the cabinet, with each drawer being slidably mounting onto a neighbouring internal sidewall and the divider wall through a pair of guide rails, comprising:
a track having an elongate body with a top end and a bottom end, the track substantially running through a height of the divider wall defining a canal along the elongate body correspondingly facing the first compartment, the body of the track carrying a plurality of cut-out profile permitting accession of the second compartment from the first compartment thereto and vice versa;
a top stoppage assembly and a bottom stoppage piece being secured to the top end and the bottom end of the track;
a plurality of triggers each mounted to an external sidewall, which is adjacent to the divider wall upon installation of the drawer to the cabinet, of a corresponding drawer;
a plurality of locking assembly each comprising (i) a pivot base, (ii) a pair of a first and a second locking cams rotatably fixed to the pivot base being moveable in between an open position and a close position in connection to the opening and closing of a corresponding drawer respectively upon engaging the first or second locking cam to the corresponding drawer through the trigger, (iii) a spacer slidably displaceable away or towards the pivot base respectively corresponding to the open position and the close position of the first or second locking cam, and (iv) at least one connector, each locking assembly secured to the track in a sequential manner around the corresponding cut-out profile and downstream of the top stoppage assembly, the first and second locking cams being positioned in the first and second compartments respectively;
at least one connection rod (joining a preceding locking assembly to an immediate succeeding locking assembly using the connector of each locking assembly; and
a coil spring sandwiched between the top stoppage assembly and a topmost locking assembly being switchable between a first compressed level and an optimal second compressed level to constantly apply a tension force towards the plurality of locking assembly positioned downstream, the coil spring of the first compressed level being compressible further to the second compressed level providing a moveable space within the canal for one of the spacers to displace away from the pivot base upon the open position adapted by the corresponding locking assembly and vice versa;
wherein the first and second locking cams of the plurality of locking assemblies engaging to the triggers of the corresponding drawers are in the close position when all the drawers are kept close in the cabinet with the coil spring adapting a first compressed level,
wherein the first or second locking cam of one of the locking assemblies adapts the open position pushing the spacer away from the pivot base when the corresponding drawer is pulled away from the cabinet compressing the coil spring to the second compressed level, the spacers of other locking assemblies are prohibited to displace further preventing opening of the corresponding drawers engaged with other locking assemblies.

2. The interlocking mechanism of claim 1, wherein the first and/or second locking cam comprises a hook raised from a circumference adjacent to a surface profile which is designated to abut and slidably displace the spacer away or towards the pivot base corresponding to opening or closing of the corresponding drawer.

3. The interlocking mechanism of claim 2, wherein the first or second locking cam adapted the open position displaces the spacer to engage with the hook of the neighbouring paired second or first locking cam in a fashion hindering rotation of the neighbouring paired second or first locking cam and prohibiting opening of the adjacent drawer.

4. The interlocking mechanism of claim 1, wherein the spacer comprises a first wedge paired with a second wedge shaped on planar surfaces of the spacer respectively protruding towards the first and second compartments that one of first and second wedges slides against the surface profile yanking the spacer progressively away from the pivot base upon turning the locking cam to the open position from the close position following opening of the corresponding drawer and the paired second or first wedge is pushed to engage with the hook of the corresponding second or first locking cam.

5. The interlocking mechanism of claim 2, wherein the surface profile comprises a convex ramp portion followed by a bevelled seat with a converging point formed in between the ramp and the seat at which the first or second wedge resting on the first or second locking cam upon the first or second locking cam adapts the open position.

6. The interlocking mechanism of claim 5 further comprising a first bump raised from the circumference adjacent to the seat to abut onto the first or second wedge and stop the first or second wedge from moving beyond upon the first or second locking cam adapts the open position.

7. The interlocking mechanism of claim 2, wherein the trigger is free from being integrated into one of the paired guide rails.

8. The interlocking mechanism of claim 1, wherein the canal is out of moveable space when the coil spring is at the second compressed level with one of the first or second locking cam of the locking assembly being switched to the open position thus prohibiting other locking assembly in the close position to adapt the open position.

9. The interlocking mechanism of claim 1, wherein the top stoppage assembly comprises a housing in which a top block fixed to the housing, a bottom block, a spring member sandwiched in between the top and bottom blocks, and a top stoppage piece engaging to the housing located immediately downstream of the bottom block.

10. The interlocking mechanism of claim 9, wherein the spring member adapts a compressed state associated to an upward displacement of the bottom block upon installation of the corresponding drawer into the cabinet for a first time and the spring member resumes a relaxed state associated to a downward displacement of the bottom block upon engagement of the locking cam with the trigger of the installed corresponding drawer.

11. An interlocking mechanism for a cabinet of a plurality of vertically stacked drawers housed in the cabinet, with each drawer being slidably mounting onto internal sidewalls of the cabinet through a pair of guide rails, comprising:
a track having an elongate body with a top end and a bottom end, the track substantially running through a height of the sidewall defining a canal along the elongate body;
a top stoppage assembly and a bottom stoppage piece being secured to the top end and the bottom end of the track;
a plurality of triggers each mounted to an external sidewall of a corresponding drawer;
a plurality of locking assembly each comprising (i) a pivot base, (ii) a locking cam rotatably fixed to the pivot base being moveable in between an open position and a close position in connection to the opening and closing of a corresponding drawer upon engaging the locking cam to the corresponding drawer through the trigger, (iii) a spacer slidably displaceable away or towards the pivot base corresponding to the open position and the close position of the locking cam, and (iv) at least one connector, each locking assembly secured to the track in a sequential manner downstream of the top stoppage assembly;
at least one connection rod (joining a preceding locking assembly to an immediate succeeding locking assembly using the connector of each locking assembly;
a coil spring sandwiched between the top stoppage assembly and a topmost locking assembly being switchable between a first compressed level and an optimal second compressed level to constantly apply a tension force towards the plurality of locking assembly positioned downstream, the coil spring of the first compressed level being compressible further to the second compressed level providing a moveable space within the canal for one of the spacers to displace away from the pivot base upon the open position adapted by the corresponding locking assembly and vice versa;
wherein the locking cams of the plurality of locking assemblies engaging to the triggers of the corresponding drawers are in the close position when all the drawers are kept in the cabinet with the coil spring adapting a first compressed level,
wherein the locking cam of one of the locking assemblies adapts the open position pushing the spacer away from the pivot base when the corresponding drawer is pulled away from the cabinet compressing the coil spring to the second compressed level, the spacers of other locking assemblies are prohibited to displace further on the track preventing opening of the corresponding drawers engaged with other locking assemblies.

12. The interlocking mechanism of claim 11, wherein the top stoppage assembly comprises a housing in which a top block fixed to the housing, a bottom block, a spring member sandwiched in between the top and bottom blocks, and a top stoppage piece engaging to the housing located immediately downstream of the bottom block.

13. The interlocking mechanism of claim 12, wherein the spring member adapts a compressed state associated to an upward displacement of the bottom block upon installation of the corresponding drawer into the cabinet for a first time and the spring member resumes a relaxed state associated to a downward displacement of the bottom block upon engagement of the locking cam with the trigger of the installed corresponding drawer.

14. The interlocking mechanism of claim 11, wherein the trigger is free from being integrated into one of the paired guide rails.
